(19) United States
(12) Patent Application Publication
(10) Pub. No.: US 2003/0023504 A1
(43) Pub. Date: Jan. 30, 2003

(54) Distributed video on demand system

(76) Inventors: Richard W. Berenson, Newton, MA (US); David Sklar, New York, NY (US); Adam Morton, Malden, MA (US); Jason Young, Somerville, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/056,672

(22) Filed: Jan. 25, 2002

Related U.S. Application Data
(60) Provisional application No. 60/264,158, filed on Jan. 25, 2001.
(60) Provisional application No. 60/276,384, filed on Mar. 19, 2001.

(51) Int. Cl. H04N 7/16; G06F 17/60; H04N 7/173

(52) U.S. Cl. 705/26; 725/87; 725/1; 725/133; 725/141; 725/153

(57) ABSTRACT

A system and method for recording purchased programming by a recording device which communicates instructions back and forth with an order processor. The order processor communicates with the user recording device as well as with a program source device to automatically ensure recording of purchased programming by a user pursuant to a user's order. The program delivery may occur at a time different from when the user views the program. The system may verify that the user recording device is capable of recording the program and may reschedule the delivery of the purchased program if the user device is unable to record the program.

### RELATED APPLICATIONS

This applications claims the benefit of the filing date of provisional application No. 60/264,158 filed on Jan. 25, 2001 and of provisional application No. 60/276,384 filed on Mar. 14, 2001 both of which are incorporated herein by reference.

### FIELD

The field of this invention is program delivery and recording systems.

### BACKGROUND

Television is an important part of many people's daily lives. TV usage has risen consistently from 6.8 hours per household per day in 1980 to 7.4 hours per day in 1999, according to Nielsen Media Research's 2000 Report on Television.

Consumers today are faced with a bewildering array of television programming choices, as additional networks and independent producers develop programs for distribution through a variety of new channels, including digital cable and the Internet. The number of channels available has grown consistently over the past 15 years. This growth greatly accelerated with the introduction of direct broadcast satellite and digital cable. The result is a fragmentation of the viewing audience and a dramatic growth in the number of options faced by each viewer.

The emergence of Video-on-Demand (VoD) and, more importantly, digital video recorders (DVRs), represents a fundamental paradigm shift in television viewing. Deutsche Bank's Alex Brown predicts that 25% of all media will be time shifted (i.e. viewed at a different time from when it is broadcast) within the next 5 years. While watching time may continue to be higher during prime time (i.e., between the hours of 8 p.m. and 11 p.m.), the shows watched may have been broadcast at 3 a.m. the previous day. This trend will increase the viewing options available to consumers even more than the growth of channels.

Both VoD and DVR systems record television programming on hard disks or other random access media and allow consumers to access that programming at a time selected by the consumer. A VoD system stores programs on a central server, then, when the consumer so requests, delivers the programs to consumers over cable lines or other physical link, or through a satellite or other wireless link. By contrast, a DVR records a regularly scheduled program at the user's premises at the time the program is broadcast. The consumer can then watch that program at a later time. DVRs convert television signals into a digital form and record that form on a hard disk or other electronic media for later playback. DVRs represent a significant advance over older time-shifting technologies, such as video cassette recorders because they allow for random access in playback. Certain providers of DVRs, such as ReplayTV, have developed systems for instructing DVRs, for example through the World Wide Web, to record specific programs at a specific time.

Consumers expect to have to pay for some content on the television—such as premium channels, pay-per-view programs, and so on. TelVue has developed a system whereby consumers can order pay-per-view programming through the World Wide Web with the cable systems serving as the billing agents. Today, pay-per-view is largely an impulse purchase because shows must be ordered from the home, typically less than an hour before the show is to be played. Hence, consumers must be at or near their television sets at the time the show is scheduled to air in order to take advantage of pay-per-view programming.

It is currently not possible to purchase television programming for viewing at a time selected solely by the viewer unless the user either acquires physical media (such as a video cassette or DVD) containing that program, or both subscribes to a service which delivers video-on-demand and is at the viewing location at the time the purchase is made.

### SUMMARY OF THE INVENTION

A system for recording purchased programming comprises device by which a user places an order for purchased programming and a recording device controller connected through at least one communication medium to a recording device, the recording device controller verifying that the recording device is programmed to record the purchased programming and the recording device controller canceling the order if it is not verified that the recording device is programmed to record the programming. The recording device is preferably a digital video recorder, and the at least one communication medium preferably includes the different medium than a transmit medium used to deliver the purchased programming. A device may be included which sends the order to a distributor of purchased programming. That device may be the recording device controller. The recording device controller may instruct the recording device to record the purchased programming and may notify the user of the status of the order. The recording device may be prevented from transferring the purchased programming to any other device.

A further embodiment of the system comprises an order processor, a program source device and a user recording device. The order processor receives and processes an order for a program, communicates commands with the user recording device, communicates commands with the program server and stores user data. The program source device communicates commands with the order processor, sends a program to the user recording device, and authorizes the receiving of the program by the user recording device. The user recording device communicates commands with the order processor, receives the program from the program service device and records the program. The user recording device may confirm its ability to receive and/or record the program. The system may further comprise a stream assembly device which selects programs for a programming stream based on predetermined criteria, creates, encrypts, and transmits the encrypted program stream, as well as creates and transmits a programming schedule for the programming stream. The user recording device may receive the programming schedule and may receive and decrypt the encrypted programming stream. The user recording device may also decrypt only a portion of the programming stream containing the program included in the order.

A further embodiment of the system comprises an order processor and a program source device. The order processor receives from a user and processes an order for a program, communicates commands with a user recording device, communicates commands with the program server, stores user data, and instructs the user recording device to record the program. The program source device communicates commands with the order processor, sends a program to the user recording device, and authorizes the receiving of the program by the user recording device. This embodiment may further comprise a stream assembly device which selects programs for a programming stream based on predetermined criteria, creates, encrypts, and transmits the encrypted program stream, and creates and transmits a programming schedule for the programming stream.

A further embodiment of the system comprises a user recording device which communicates commands with a program controller, receives a program from a program service device, and records the program pursuant to a command from the program controller. In a further embodiment, the program is received along the same medium as the commands.

A method is also offered for producing an encrypted programming stream comprising receiving program orders, selecting programs based on the program orders, assembling the selected programs into a sequential stream of programming, and encrypting the sequential stream. A further embodiment includes publishing the schedule of programs, preferably in electronic form and/or over the Internet.

A further embodiment of the system for recording purchased programming comprises a recording device that receives purchased programming, records purchased programming, and communicates instructions with a program delivery mechanism; the programming delivery mechanism receives at least one order for purchased programming, sends purchased programming, communicates instructions with the recording device, and instructs the recording device to record the purchased programming. A further embodiment includes encoding and decoding the purchased programming. The decoding may be performed by either the recording device or a decoding device which sends the decoded purchased programming to the recording device.

A further embodiment of the system comprises a programming delivery mechanism that receives orders for purchased programming, communicates instructions with a recording a device, instructs the recording device to record the purchased programming and verifies that the recording device is programmed to record the purchased programming. In a further embodiment, if the recording device is not programmed to record the purchased programming, the programming delivery mechanism may cancel the order, send a notification that the order was canceled, reschedule the order, and/or instruct the recording device to record the purchased programming according to the rescheduled order. The programming delivery mechanism may also send the purchased programming to the recording device, and/or encode the purchased programming.

A further embodiment of the system comprises a recording device that receives purchased programming, records purchased programming, communicates instructions with a programming delivery mechanism, and verifies to the programming delivery mechanism that it is programmed to record a particular purchased program. The recording device may further display, decode, or encode the particular purchased program.

A method is further offered comprising placing an order for purchased programming, verifying that a recording device is programmed to record the purchased programming, and if it is not verified that the recording device is programmed to record the programming, either canceling the order, attempting to reschedule the order, or notifying the entity which placed the order. The recording device may be a digital video recorder. The order may be placed over the Internet. The order may be sent to a distributor of purchased programming. The recording device may be instructed to record the purchased programming. The verifying may include verifying that the recording device cannot transfer the program to any other device.

### BRIEF DESCRIPTION OF THE DRAWINGS

In the drawings, in which like reference numerals indicate like elements:

FIG. 1 shows an overview of a program ordering system;

FIG. 2 shows a flowchart showing the operation of a program ordering system;

FIG. 3 is a chart of how user settings may effect notifications and reminders;

FIG. 4 shows an overview of a system for creating custom program channels.

### DETAILED DESCRIPTION

Embodiments of the present invention allow the planning and execution of a purchase of television programming to be viewed at a time of the purchaser's choosing without the purchaser being at the viewing location near the time of broadcast and without the purchaser's subscribing to a video-on-demand service. This new capability has many advantages over the current state of the art. It allows viewers greater flexibility regarding when and how viewers make decisions about television programming. It also allows the distributors of television programming to precipitate purchases of their programming at times and places not currently possible-such as while the purchaser is at work, traveling, or otherwise away from the viewing location. Embodiments of the invention allow individuals to purchase premium programming over the Internet, or another medium, and have that programming recorded on a Video Recorder (“VR”) located at home or elsewhere, for later playback at any time.

In one embodiment, an individual accesses a World Wide Web site containing listings of the programming available for purchase. The individual then selects a program and indicates through the user interface of the site a desire to purchase the program and have it stored on his VR for later viewing. The site will then communicate with both the distributor of the program (for example, a cable system or direct broad satellite system) and with the VR, coordinating their respective responses to maximize the likelihood that the program is only purchased if the VR is able to record it.

Such a VR-based VoD system has a technical advantage over server-based VoD in that the time shifting ability makes more efficient use of cable bandwidth, which can be clogged in server-based VoD systems if many users order programs for delivery at the same time. The ability of the VR based system to time shift and coordinate with individual VRs allows the scheduling of programs if demand for different programs exceeds the ability to broadcast them simultaneously. This bandwidth clogging is a particular problem for satellite-based distribution systems. A typical digital cable or satellite based distribution system may have up to 500 channels available for delivering programming to the end user. A single user ordering a VoD program uses one of those channels. Thus, if 500 people ordered VoD programs, there would be no bandwidth left for serving the regular, non-pay channels. On a typical cable system head-end with over 500,000 subscribers, this is a significant problem—particularly at evening prime viewing time.

To solve this problem and make VoD systems practical, cable systems would need to assign programs to particular channels at the network nodes (which are the last branching points before cable goes to the home and which may serve less than 1,000 people) rather than at the head-end. Since less than 10% might order VoD at peak viewing time, the system could easily dedicate 100 channels to VoD delivery without significantly restricting the number of channels available for other purposes. However, this solution is very expensive, requiring significant equipment upgrades both at the head-ends and in the field. Further, this solution is not practical for satellite-based distribution systems, which operate transponders (the equivalent of cable head-ends for satellite-based systems) which broadcast to the entire country and hence have no local nodes to use to multiply the number of channels which could be devoted to individual VoD streams. As a result, there is no current technology which works well for delivering VoD service via satellite distribution systems.

The VR based VoD system solves this problem by shipping programs during non-peak hours (when there is significant underutilized bandwidth) to local storage devices (VRs) located at the user premises, thereby enabling satellite-based distribution systems to deliver VoD services. Because such a system does not require assigning channels at the local nodes, it is far less expensive for cable systems to implement than are traditional VoD systems. A VR-based system also does not require the purchase of centralized servers for storing programming for time-shifting. Because consumers can be induced to purchase VRs for their other advantages (such as time shifting free programming, pausing programming, and so on), a VR-based VoD system is significantly less expensive for any programming distributor to set up than is a central server-based VoD system. While the VR-based VoD system is preferably used with digital video recorders, VRs using cassettes or other media may also be used provided that the individual VR is capable of interfacing with the system as described herein.

One challenge in operating a VR-based VoD system lies in the uncertainty involved in communicating with the distributor of the programming (such as the cable or satellite television system or network) and with the VR itself: if the VR is not successfully instructed to record the program, the purchaser may end up paying for a program which is never received or recorded. This may occur, for example, if there is a communication problem with the VR, or if there is a problem with the VR itself, such as the VR being out of storage space. Alternately, if the distributor turns down a program purchase for any reason after the VR has been instructed to record, the VR could end up recording static. A further complication lies in the method of ordering pay-per-view programming. A show frequently may only be ordered less than one hour before the start of the show. Advanced orders cannot be placed, potentially leaving insufficient time to reach the VR and instruct it to record the program.

In one embodiment, the user first registers with the system through a Web site. During the registration process, the user enters information about available programming distributors and VR(s) so that program orders may be taken using a simplified process that does not require re-entering this information. Certain additional information, including eligibility to purchase certain types of programming, such as adult content programming, may be collected. In one embodiment, access to this information is protected through a password or some other form of electronic identity verification.

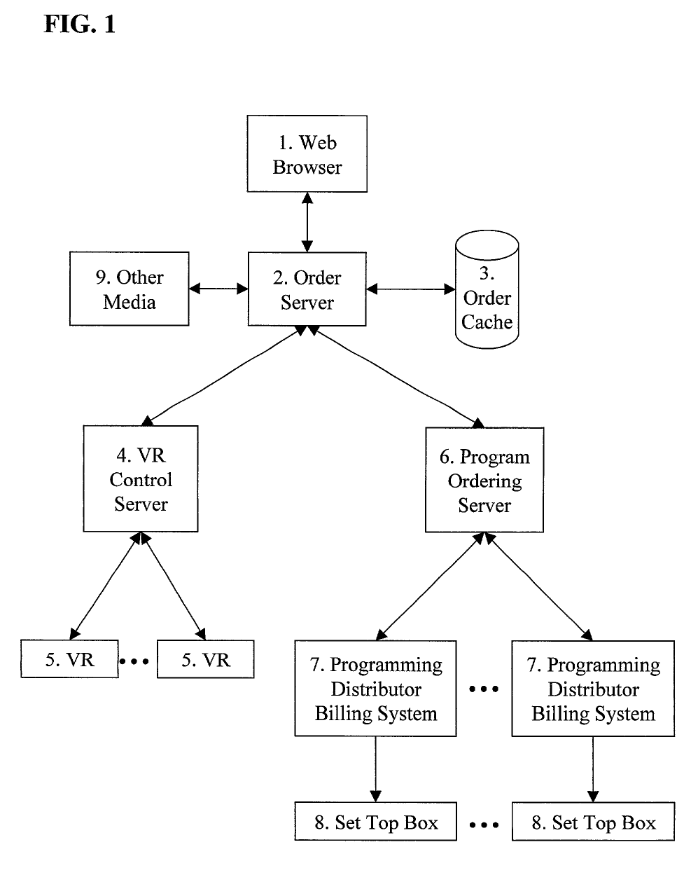

FIG. 1 shows an overview of one embodiment of the system. A User interacts with the Order Server (2) through a Web Browser (1) to place an order for a pay-per-view program. The Order is stored in the Order Cache (3). The Order Server (2) then sends the order to the VR Control Server (4), which attempts to instruct the user's VR(s) (5) to record the appropriate channel at the appropriate time. The connections between the VR Control Server (4) and the VRs (5) may be over one or more of a variety of media. These connection allow for the passing of data in both directions: from the VR Control Server (4) to the VRs (5) and from the VRs (5) to the VR Control Server (4). Information sent from the VR Control Server (4) to the VRs (5) may be sent using a different media and/or different connection from the information sent from the VRs (5) to the VR Control Server (4). The VR(s) (5) then acknowledges receipt of and plan to comply with the instruction to the VR Control Server (4), which passes the acknowledgement back to the Order Server (2) which updates the Order Cache (3).

The Order Server (2) continually monitors the Order Cache (3). When acknowledgement from a VR has been received within the time range which an order may be placed for the programming (this range is called the “Order Window”), the Order Server (2) sends the Order to the Program Ordering Server (6). The Program Ordering Server (6) communicates with the billing system of the programming distributor (7) to place the order. The Programming Distributor Billing System (7) instructs the Set Top Box (8) to decode the ordered program when it is transmitted. The Programming Distributor Billing System (7) also sends an acknowledgement back to the Program Ordering Server (6) which sends it to the Order Server (2) which updates the Order Cache (3).

The duration of the Order Window, as described above, is determined by an algorithm which may consider order processing queues and may also consider whether the Order has been pre-qualified; If the Order was not pre-qualified, the order may be placed earlier in the queue so that if the Order fails, the user may be notified in time to make other arrangements for placing the programming purchase order or acquiring alternative entertainment. This will help prevent the situation where a user is billed for a program which the user is unable to view.

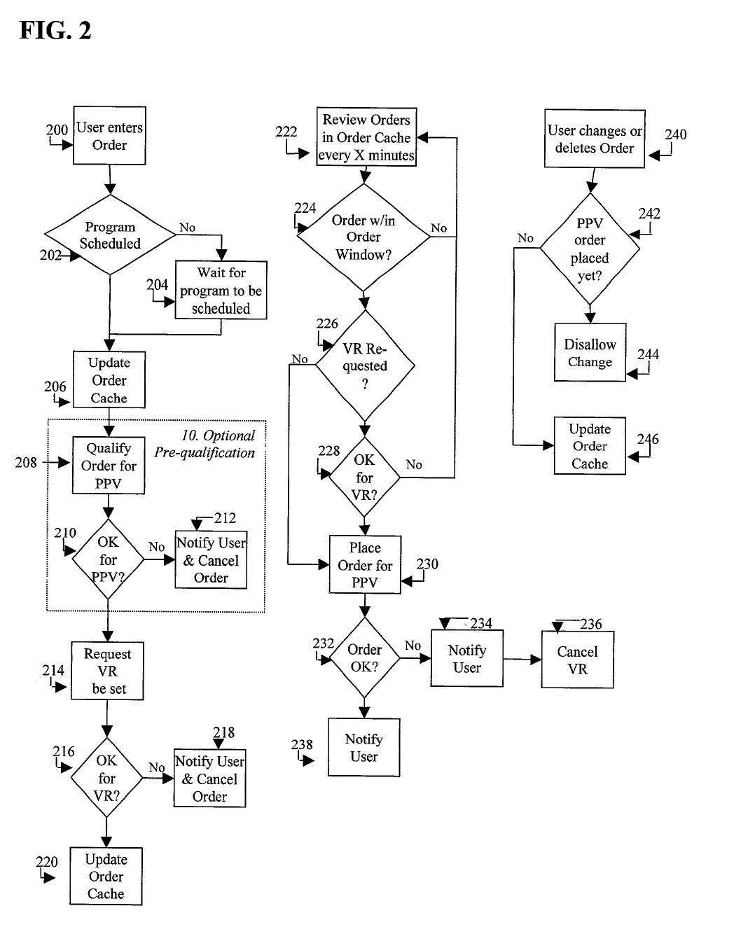

FIG. 2 is a logic flow diagram for one embodiment of the system's operating algorithm. Under this system it is not necessary for a user to wait until a pay-per-view program is scheduled before placing an order. The system may hold an order for a specific unscheduled program until that program is scheduled.

A user enters an order for a program purchase (200). The system then checks to see if the program is scheduled (202). If the program is scheduled the system updates the order cache (206) with the user's program order after determining which instance of the program on the schedule the order is for, possibly by matching the schedule of when the program will be available for recording with the availability of the VR. In one embodiment, this matching may also consider the likely schedule of the VR—such as, for example, that it is likely to be otherwise used during prime time or that it is already scheduled to record other programs at particular times. If the program is not scheduled the system waits for the program to be scheduled (204) and then updates the order cache (206). The system may then initiate an optional prequalification (10). This optional prequalification may happen during the registration process or after the order is placed. The latter is preferred because purchase qualification may change over time depending, for example, on the user's credit status with the programming distributor. However, not all Programming Distributors may be able to provide pre-qualification, so the step is optional.

Once qualification has been established, the system then sends a request for the VR to record the program (214). If the VR is able to record the program, the system updates the order cache accordingly (220). If the VR is unable to record the program, the system may cancel the order and notify the user accordingly (218).

The system regularly reviews the orders in the order cache (222) according to a predetermined interval. If an order is made within the order window (224), the system will request activation of the VR to record the program (226), if it has not already done so. If the order is not in the order window or the VR is unable to record the program, the orders will remain in the order cache. If the VR is able to record the program, the system will place the order (230) and verify the status of the order (232). If the order is proper and verified, it will proceed and the user will be notified (238). If there is an error with any necessary aspect of the order, the system will notify the user (234) and cancel the order to record the program with the VR 236.

If the user attempts to change or delete an order (240) the system will check to see if the order has been placed (242). If the order has been placed, the system will disallow the user's change (244); if the order has not been placed, the system will accept the user's change or deletion and update the order cache (246) accordingly.

In one embodiment, referring again to FIG. 1, the user may access the Order Server (2) through the Web Browser (1) at any time in order to determine the status of the Order. In the preferred embodiment, the user may cancel or otherwise change the Order using the Web Browser (1). In another embodiment, the Order Server (2) may also send notifications and reminders to the individual who ordered the programming through a variety of Other Media (9). Other Media (9) may include, without limitation, any one or more of: e-mail, telephone, instant messenger, calendar-based reminders, PDAs (personal digital assistants), pagers, cell-phone or other wireless data protocols such as WAP, or telecomputer which delivers a voice message to a cell- or land-line telephone. A notification may be sent to inform the user of a change of status of his order. A reminder may be sent to a user to prompt the user to take some action, such as turn on the VR or watch a scheduled program.

At any point during this process, error messages may be returned. Some of these messages may cause an order to be stopped and not processed. Others may trigger a notification or cause a reminder to be scheduled. For example, the VR (5) may report a conflict that prevents it from recording a requested program at a particular time. The system may automatically reschedule the recording of the program to a time when the VR (5) has no conflict. Furthermore, the system may keep a record of these conflicts that it may, in turn, then report them to the programming distributor for use in changing the broadcast schedule.

In another embodiment, the VR (5) may send an error message if it can no longer record a program which it had previously indicated it could and/or committed to record. Such a situation might occur, for example, if the VR (5) is turned off or reset, if it becomes filled-up by programs which were recorded between the its prior commitment and the promised execution date, or if the remotely set instructions are locally or manually changed. Such an error may be sent by the VR (5) upon the occurrence of such a change in availability. However, in one embodiment, the VR Control Server (4) queries the VR (5) for status either just before the program order is actually placed, or just before the program is actually to be recorded, or both. In a further embodiment, the VR Control Server (4) also receives a confirmation of successful recording of the program from the VR—either initiated by the VR (5) or in response to a query by the VR Control Server (4).

Also in an embodiment, the system communicates any such errors (a) to the programming distributor billing systems in order that appropriate credits (if any) might be issued; and/or (b) to the Order Server (2) in order that another attempt to properly download the purchased program might be attempted; and/or (c) to the VR (5) in order that the results of any such failed attempt be deleted from the VR (5) in order to free up space for future recordings.

In an alternative embodiment, the functionality of all servers may be combined to run on a single machine. The Order Server (2), Order Cache (3), VR Control Server (4), Program Ordering Server (6) and Programming Distributor Billing System (7) may exist on similar machines in certain embodiments of the DVR based system. For example, the Order Server (2), Order Cache (3), VR Control Server (4) and Program Ordering Server (6) and Programming Distributor Billing System (7) may all exist on the same machine if the system is implemented in a centralized embodiment. Other, decentralized embodiments may implement the Order Server (2), Order Cache (3), VR Control Server (4) and Program Ordering Server (6) on one machine. Another embodiment may implement the Order Server (2), Order Cache (3), and VR Control Server (4) on one machine and the Program Ordering Server (6) and Programming Distributor Billing System (7) on a second machine. Further embodiments may implement the Order Server (2), Order Cache (3), VR Control Server (4), Program Ordering Server (6) and Programming Distributor Billing System (7) in any number of combinations, giving different machines different functionality. For purposes of illustration, FIG. 1 shows each structural element separately.

In an alternate embodiment, the functionality of the Web Browser (1), Order Server (2), VR Control Server (4) and/or the Program Ordering Server (6) may be combined into either the VR (5) or the Set Top Boxes (8). A combination of the VR Control Server (4) and the Order Server (2) may be configured by the user to send a reminder to turn on and program the VR (5), and to confirm through the Web Browser (1) or through other media such as a two way pager, e-mail, a touch tone telephone, and so on, that the VR (5) has been programmed accordingly. This functionality may also be combined with that of the Order Server (2). In one embodiment, the user may simply ask the system to send a reminder to order the program, through some other method and/or media such as the telephone via a human operator or an automated response system, to insure the program will be available when the VR (5) tries to record it.

Furthermore, other configurations and arrangements of the system components are possible. For example, the Order Server (2), VR Control Server (4), and Program Ordering Server (6) may all be run on the same machine or be functionality within a single software architecture. In another example, in situations where the VR (5) is part of or connected to the Set Top Box (8), the VR Control Server (4) may communicate with the Programming Distributor Billing System (7) and/or be part of the system which instructs the Set Top Box (8) to unscramble a program. A wide variety of other combinations are also within the scope of this invention. The VR (5) may be a DVR, but may also be any video recording system which is capable of receiving instructions from a remote server, such as a video cassette recorder, a game console, or a personal computer. The Set Top Box (8) may also be any piece of equipment or software which controls channel receipt and selection, including without limitation, a game console or a personal computer.

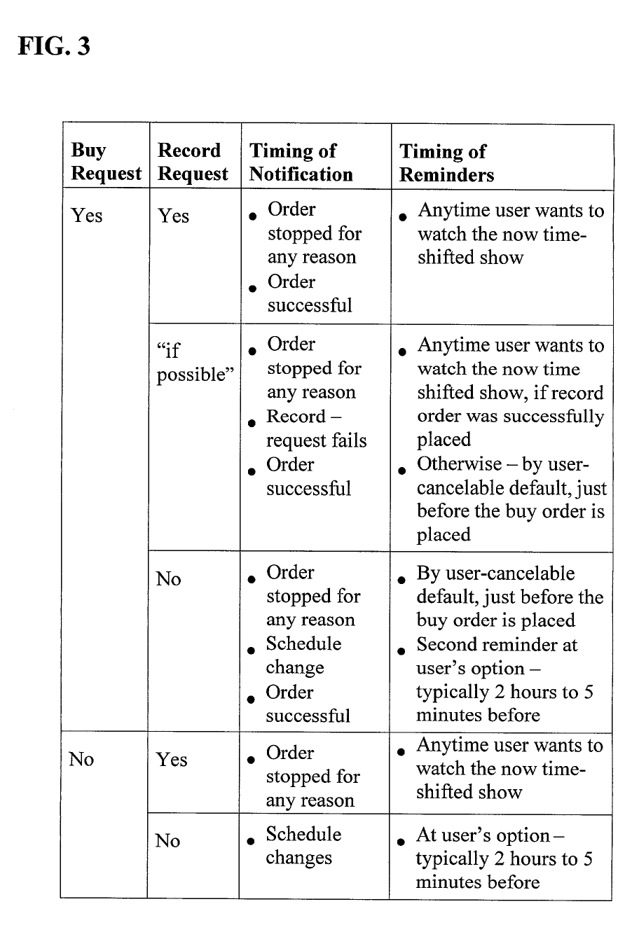

In another embodiment, the VR confirmation element of an Order may be performed only at the user's option. Thus, if the user so requests, an Order need not require VR status confirmation. In one embodiment, the system would automatically, or optionally, send a reminder to the user to watch a program that has been purchased or that is regularly scheduled and does not require a purchase. FIG. 3 shows the impact that some of these possible user-determined Order settings may have on notifications and on reminders.

Because programming may be purchased in a variety of ways, the system may be flexible in how it handles orders. For example, programming may be purchased by paying to have a channel's signal unscrambled for only the duration of the program (“event purchases”), for an entire day (sometimes called “all day movie tickets”) or for longer periods of time, such as an entire month (sometimes called a “temporary premium channel upgrade”). In one embodiment, referring once again to FIG. 1, the system will place an Order with the Program Ordering Server (6) before the desired program is to be run, and will be able to inform the user if a previously purchased programming block already covers the program the user desires to purchase.

In one embodiment, the VR (5) has a means for reliably identifying its characteristics to the VR Control Server (4). One example of such a characteristic is whether or not the VR (5) has the ability to transfer recorded programming to mobile media, such as a flash card, tape or removable magnetic, CD-R, or other disk. In an additional embodiment, this information may be used to determine whether the particular VR (5) may be used to record a particular program. In another embodiment, the program stored on the media for the VR (5) may be encrypted or otherwise locked, for example using a code uniquely associated with that particular VR so that the program may not be accessed if the media is moved to a different VR. These features may allow greater flexibility in pricing of pay programs because they can give the program's copyright owner/licensor some assurance that the program would not be viewable except at a specific location. Protective features such as these can be very important when digital content can be copied and transferred very easily.

In another embodiment, the streams of programming, such as pay-per-view channels, which are delivered to a decryption device, such as a Set Top Box (8) are encrypted. A list of the programming which is contained in this encrypted stream is presented to a user, including without limitation, through a Web page, a set top box display, or wireless device. The user may select one or more programs from the list. The selection is communicated to the Set Top Box (8), and to the VR (5). In one embodiment, the VR (5) may be located near the viewing device, such as a television. In an alternative embodiment the VR (5) may be located on a local server which provides programming streams to one or more displaying devices over a local or wide area network (such as a hospital, school, or office environment). In this embodiment, it is preferred that the local server is owned by the purchaser of the programming and not by the distribution system. Receipt of the selection information triggers the decryption device (Set Top Box (8)) and the recording device (VR (5)) to decrypt and record the program for later local display on demand.

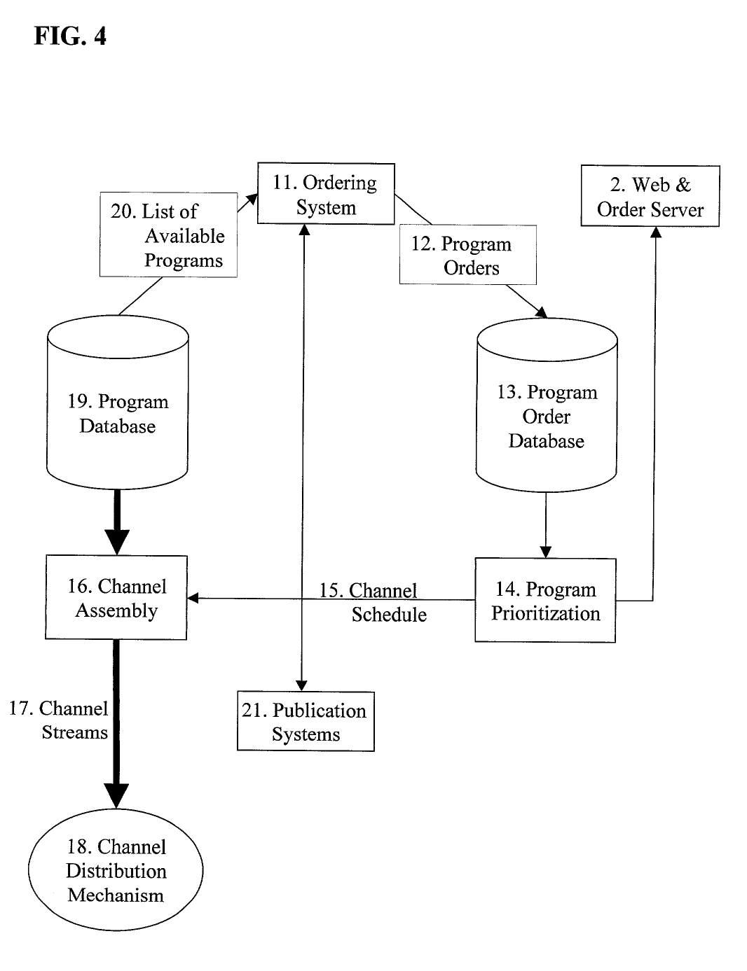

In one embodiment, channels on a distribution mechanism are used during off peak hours to deliver special programming streams containing content that has been purchased by users. These streams may be assembled nationally, regionally, or locally based on orders received by the program content provider. In one embodiment, these channels are assembled as illustrated in FIG. 4, now described.

Programming orders are taken by an Ordering System (11), preferably an electronic system with an interface such as a Web site or a program guide on a set top box. The Ordering System (11) may list some or all of the programming available for purchase (20), for example in the form of an episode guide for television series or a set of movie reviews by genre. A user may select and order programming for purchase. The resulting Program Orders (12) may then be stored in a Program Order Database (13).

Based on the Orders received, the Ordering System (11) may prioritize (14) to determine which programs to insert when into each of its channel streams. The algorithm for prioritizing may consider, among other factors, the number of times each program is currently ordered or was ordered historically, whether a program has already been scheduled, how many VRs are capable of recording the program, and whether users have paid any premium delivery fees as part of their orders. In one embodiment, once previously scheduled programs are deleted from the list of available programs, the resulting list is sorted based on the number of orders which have been placed for each program, with each premium delivery order weighing heavier for the purpose of sorting. This weighting and sorting will allow a Channel Schedule (15) to be determined which maximizes the benefit of the considered factors by placing programs in time slots according to the weighting and sorting.

Once the Channel Schedule (15) has been determined, it may be passed to the Channel Assembly System (16), back to the Ordering System (11) and/or, optionally, to other electronic or print Publication Systems (21). The Channel Assembly System (16) pulls the content from the Program Database (19) and, at the times determined by the channel schedule, encrypts and passes on the resulting Channel Streams (17) to one or more Channel Distribution Mechanisms (18). The Channel Assembly System (16) may be easily built using standard video editing and video on demand systems known in the art. The encryption may be by any number of industry standard encryption schemes, including those designed to be decrypted by set top boxes.

The program prioritization system (14) may notify the Order Server (2) of the program order or a specific channel, which may create an order for the purchase and recording of the program ordered by the user. In a preferred embodiment, the distributed video on demand system is part of or works closely with the electronic Ordering System (11) through which the original order was placed. For example, the Program Order Database (13) and the Order Cache (3) may be the same database.

In one embodiment, the user may be notified through any media when the program will become available, preferably by the Ordering System (11) or the Order Server (2).

In another embodiment, the system may instruct the VR (5) to erase a recorded show after a specified time or number of watchings. This capability allows for greater flexibility in the pricing of the program to be purchased.

Many other configurations of the described system are possible and within the scope of the invention. For example, the programming distribution system may be a coaxial cable, fiber optic, DSL or other telephone, satellite broadcast or other wireless transmission, Internet-based, or any other system including systems of mixed or hybrid media. The programming can be audio, video, multi-media, interactive, or any other sort of programming. The recorder, as described, may be a video recorder, but it may also be an audio recorder or any other device capable of receiving programming and fixing it in a tangible medium. This would allow the system to deliver audio programming to mobile devices, such as stereos, or data programming, such as news or software, to personal computer or other devices. Orders placed over the Internet could alternatively be placed over any physical or wireless wide area network or combination of networks. Other examples will also be apparent.

What is claimed is:

1. A system for recording purchased programming, the system comprising:
a device by which a user places an order for purchased programming; and
a recording device controller connected through at least one communication medium to a recording device, the recording device controller verifying that the recording device is programmed to record the purchased programming and the recording device controller canceling the order if it is not verified that the recording device is programmed to record the programming.

2. The system of claim 1, wherein the recording device is a digital video recorder.

3. The system of claim 1, wherein the at least one communication medium is a different medium than a transmit medium used to deliver the purchased programming.

4. The system of claim 1, further comprising a device which sends the order to a distributor of the purchased programming.

5. The system of claim 1, wherein the recording device controller sends the order to a distributor of purchased programming.

6. The system of claim 1, wherein the recording device controller instructs the recording device to record the purchased programming.

7. The system of claim 1, wherein the recording device controller notifies the user of a status of the order.

8. The system of claim 1, wherein the recording device cannot transfer the purchased programming to any other device.

9. A system for the delivery of programming, the system comprising:
an order processor;
a program source device; and
a user recording device;
the order processor executing instructions to:
receive from a user and process an order for a program,
communicate commands with the user recording device,
communicate commands with the program server, and
store user data;
the program source device executing instructions to:
communicate commands with the order processor,
send a program to the user recording device, and
authorize the receiving of the program by the user recording device; and
the user recording device executing instructions to:
communicate commands with the order processor,
receive the program from the program service device, and
record the program.

10. The system of claim 9, the user recording device further executing instructions to confirm its ability to receive and/or record the program.

11. The system of claim 9, further comprising:
a stream assembly device;
the stream assembly device executing instructions to:
select programs for a programming stream based on predetermined criteria,
create the programming stream,
create a programming schedule for the programming stream,
encrypt the programming stream,
transmit the encrypted programming stream, and
transmit the programming schedule.

12. The system of claim 11, further comprising:
the user recording device further executing instructions to:
receive the encrypted programming stream;
receive the programming schedule; and
decrypt the encrypted programming stream.

13. The system of claim 11, further comprising:
the user recording device further executing instructions to:
receive the encrypted programming stream;
receive the programming schedule; and
decrypt a portion of the programming stream containing the program included in the order.

14. A system for the delivery of programming, the system comprising:
an order processor; and
a program source device;
the order processor executing instructions to:
receive from a user and process an order for a program,
communicate commands with a user recording device,
communicate commands with the program server,
store user data, and
instruct the user recording device to record the program;
the program source device executing instructions to:
communicate commands with the order processor,
send a program to the user recording device, and
authorize the receiving of the program by the user recording device.

15. The system of claim 14, further comprising:
a stream assembly device;
the stream assembly device executing instructions to:
select programs for a programming stream based on predetermined criteria,
create the programming stream,
create a programming schedule for the programming stream,
encrypt the programming stream,
transmit the encrypted programming stream,
transmit the programming schedule.

16. A system for the delivery of programming, the system comprising:
a user recording device executing instructions to:
communicate commands a program controller,
receive a program from a program service device, and
record the program pursuant to a command from the program controller.

17. The system of claim 15, further comprising:
the user recording device further executing instructions to:
receive an encrypted programming stream;
decrypt a portion of the encrypted programming stream; and
record at least part of the decrypted portion of the program stream pursuant to a command from the program controller.

18. The system of claims 16 or 17, wherein the program is received from the program service device along the same medium as the commands are communicated with the program controller.

19. A method for producing an encrypted programming stream, the method comprising:
receiving program orders;
selecting programs based on the program orders;
assembling the selected programs into a sequential stream of programming; and
encrypting the sequential stream.

20. The method of claim 19, further comprising publishing a schedule of the programs contained in the sequential stream.

21. The method of claim 20, wherein the publishing is electronic.

22. The method of claims 19 or 21, wherein the publishing is over the Internet.

23. A system for recording purchased programming, the system comprising:
a recording device that performs actions comprising:
receiving purchased programming,
recording purchased programming, and
communicating instructions with a programming delivery mechanism; and
the programming delivery mechanism that performs actions comprising:
receiving at least one order for purchased programming,
sending purchased programming,
communicating instructions with the recording device, and
instructing the recording device to record the purchased programming.

24. The system of claim 23, wherein the actions performed by the programming delivery mechanism further comprise encoding the purchased programming.

25. The system of claim 23 or 24, wherein the actions performed by the recording device further comprise decoding the purchased programming.

26. The system of claim 23 or 24, further comprising:
a decoding device that performs actions comprising:
decoding the purchased programming; and
sending the decoded purchased programming to the recording device.

27. A system for recording purchased programming, the system comprising:
a programming delivery mechanism that performs actions comprising:
receiving an order for purchased programming;
communicating instructions with a recording device;
instructing the recording device to record the purchased programming; and
verifying that the recording device is programmed to record the purchased programming.

28. The system of claim 27, wherein the actions performed by the programming delivery mechanism further comprise:
if the recording device is not programmed to record the purchased programming perform one or more of the following functions:
cancel the order;
send a notification that the order was cancelled;
reschedule the order; and
instruct the recording device to record the purchased programming according to the rescheduled order.

29. The system of claim 27 or 28, wherein the actions performed by the programming delivery mechanism further comprise sending the purchased programming to the recording device.

30. The system of claim 29, wherein the actions performed by the programming delivery mechanism further comprise encoding the purchased programming.

31. A system for recording purchased programming, the system comprising:
a recording device that performs actions comprising:
receiving purchased programming;
recording the purchased programming;
communicating instructions with a programming delivery mechanism; and
verifying to the programming delivery mechanism that the recording device is programmed to record a particular purchased program.

32. The system of claim 31, wherein the actions performed by the recording device further comprise displaying the particular purchased program.

33. The system of claim 31, wherein the actions performed by the recording device further comprise decoding the purchased programming.

34. The system of claims 31, 32 or 33, wherein the actions performed by the recording device further comprise encoding the particular purchased program.

35. A method for recording purchased programming, the method comprising:
placing an order for purchased programming;
verifying that a recording device is programmed to record the purchased programming; and
if it is not verified that the recording device is programmed to record the programming either:
canceling the order,
attempting to reschedule the order, or
notifying the entity which placed the order.

36. The method of claim 35, wherein the recording device is a digital video recorder.

37. The method of claim 35, wherein the order is placed over the Internet.

38. The method of claim 35, further comprising sending the order to a distributor of the purchased programming.

39. The method of claim 35, further comprising instructing the recording device to record the purchased programming.

40. The method of claim 35, wherein the verifying includes determining that the recording device cannot transfer the program to any other device.
